(19) United States
(12) Patent Application Publication
(10) Pub. No.: US 2021/0081892 A1
(43) Pub. Date: Mar. 18, 2021

(54) GLOBAL POSITIONING SYSTEM DETERMINATION

(71) Applicant: Corey Coogan, Green Bay, WI (US)

(72) Inventor: Corey Coogan, Green Bay, WI (US)

(21) Appl. No.: 17/005,576

(22) Filed: Aug. 28, 2020

Related U.S. Application Data
(60) Provisional application No. 62/901,015, filed on Sep. 16, 2019.

(51) Int. Cl. G06Q 10/08; G01C 21/34; G01C 21/36

(52) U.S. Cl. CPC G06Q 10/0833; G06Q 10/0835; G01C 21/3626; G01C 21/3605; G01C 21/3415

(57) ABSTRACT

A system may include a non-transitory computer readable medium and a processor. The non-transitory computer readable medium may include instructions executable by the processor to transmit a message including an interactive link to a mobile device. Instructions may further be executable by the processor to receive a notification that the link has been interacted with and, in response, determine a global positioning system (GPS) coordinate from the mobile device. Further instructions may be executable to map the determined GPS coordinate, which may include instructions executable to map the GPS coordinate onto a pre-determined route.

### PRIORITY CLAIM

This application claims priority to U.S. Provisional Patent App. No. 62/901,015, filed on Sep. 16, 2019, the contents of which are hereby incorporated by reference.

### BACKGROUND

Load tracking, such as in the trucking industry, allows both carriers and shippers to monitor the location and timing of deliveries. Accurate tracking allows a shipper to ensure that a carrier remains on route and on time. The shipper is further able to provide the end customer with updates regarding the shipment and address any issues, such as rerouting, that arise during transportation.

### BRIEF DESCRIPTION OF THE DRAWINGS

FIG. 1 is an example system for global positioning system determination consistent with the present disclosure.

FIG. 2 is an example method for global positioning system determination consistent with the present disclosure.

FIG. 3 is an example process flow for global positioning system determination consistent with the present disclosure.

### DETAILED DESCRIPTION

Supply chain management and supply chain visibility form an integral part of multiple industries. One of these industries is the trucking/transportation industry. Within the trucking industry, supply chain management is necessary to coordinate deliveries of multiple types of products, often across state lines, by a variety of carriers and to a variety of customers. A single transportation job may include logistics involving loading a truck, transport time, transport route, and unloading the truck. In addition, the logistics must account for a variety of additional federal and state regulations, including mandatory rest periods, road construction, and available routes.

One part of supply chain management is supply chain visibility. Monitoring the transportation (or whatever is being managed) provides ongoing insight regarding the job in question. For example, instead of giving a truck driver a deadline to make a delivery and then ceasing monitoring, supply chain visibility allows a shipper to confirm that not only is the driver on schedule but also ensure that all applicable regulations, such as those regarding rest periods, are being followed. Similarly, by engaging in ongoing monitoring of the route being used, the shipper is able to note any changes from a suggested route; in turn, this may reveal unforeseen issues (e.g., unknown construction) that can be used to adjust future routes.

Until recently, one of the primary ways to track a driver was through ping technology. Ping technology relies on a cellular telephone connecting to a particular cell tower. By identifying the particular tower that the cell phone has connected to, the location of the phone can be identified. This location identification through use of the cell tower is known as “pinging”. Since the cell tower is located at a particular and known place, the location of the connected cell phone can be determined with relative accuracy based on where the cell phone most recently pinged. Cell phone carriers would sell or otherwise provide ping locations of their customers to load tracking companies, allowing the company to track loads using the pings of a driver's cell phone. However, several of these load tracking companies and cell phone carriers became subjects to privacy lawsuits involving their use of this pinging technology, with the result that pinging (at least, as outlined above) is no longer available as an option for load tracking.

Currently, there are three primary ways to track loads and provide supply chain visibility in the trucking industry. The first involves sharing of electronic logs. As a driver transports a shipment, he is required to update an electronic log. The electronic log includes information such as miles driven, time, and location. By sharing the electronic log with a shipper, a driver is able to update the shipper with their location throughout a transport. However, implementing sharing of electronic logs has a higher setup cost, as both the driver and the shipper need specific equipment, including networking equipment and computers, to successfully implement the sharing. As a result, electronic log sharing is often only feasible and worthwhile when a driver and a shipper will have a long-term relationship (e.g., the driver is working specifically for a shipping company and not as an independent contractor).

Another method for tracking a load and ensuring supply chain visibility is through the use of an application, or app, on a driver's cell phone. A driver downloads an app and, through the app, the location of the cell phone can be tracked. Often, this is done through technology similar to the pinging technology described above; the app collects information regarding the cell towers the cell phone is connecting with and, through the app, relays the GPS location to a shipper, dispatcher, customer, or any combination thereof. Use of app-based tracking, however, has several drawbacks. First, it requires that a driver download an app onto his or her cell phone, which is often a personal phone. Understandably, drivers may be reluctant to do this, as they may not wish to have an employer be able to track their phones when the driver is “off the clock”, so to speak, which is a privacy issue. In addition, multiple companies offer such app-based tracking services; thus, for drivers who are independent contractors, the app they need to use is likely to change based on which company they are providing transportation for. As a result, a driver may need to download multiple versions of essentially the same technology, which takes up space in the cell phone's memory. Finally, drivers may be reluctant to have their location tracked in real time. A driver may be concerned about privacy (e.g., having someone know precisely where they are at any given time) or simply not feel that such constant monitoring is needed.

A third method for load tracking involves telephone calls between a driver and a dispatcher. The dispatcher may call the driver at predetermined or regular intervals and inquire as to the location of the driver. However, telephone calls may result in less precise locations, as a driver may not know exactly where he is, but only have a general idea. In addition, depending on the location, cell phone coverage (i.e., the ability of the driver's phone to make and receive calls) may be limited. Finally, in a fleet with a large number of drivers, telephonic load tracking is time consuming, as each individual driver needs to be called separately.

By contrast, global positioning system determination in accordance with the present disclosure allows load tracking without requiring a driver to download additional phone apps or use additional programs for electronic log sharing. A message, such as a text message, is transmitted to a driver's cell phone or other mobile device. The message includes a load specific link that the driver is able to interact with by, for example, clicking on the link. Once the driver interacts with the link, a GPS coordinate for the mobile device is determined using the mobile device's Internet browser data and information. The GPS coordinate can then be mapped or added to a log for the driver. Global positioning system determination in accordance with the present disclosure allows load tracking, and thus supply chain visibility, by leveraging settings already present in a cell phone (i.e., phone browser location settings) in such a way that the driver does not have to subject himself to continuous monitoring. In addition, because no app is required, drivers who are independent contractors are able to use this load tracking system regardless of which company they are driving for at any particular time; as long as the company is using global positioning system determination consistent with the present disclosure, any driver is able to interact and send GPS locations back via interaction with the message.

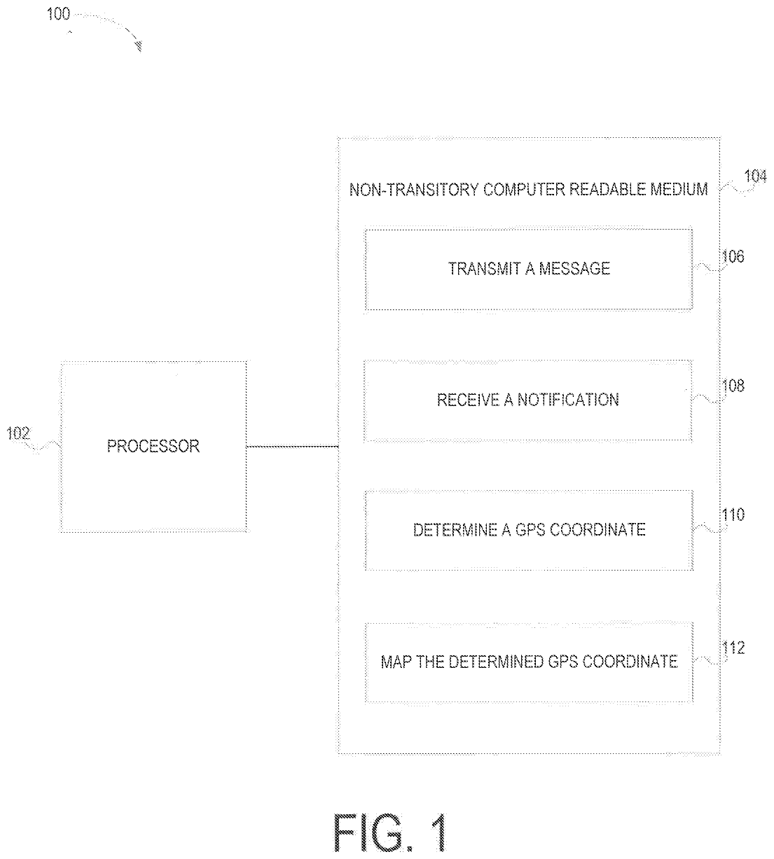

FIG. 1 is an example system 100 for global positioning system determination consistent with the present disclosure. System 100 may include a processor 102. Processor 102 may be one or more central processing units (CPUs), microprocessors, and/or other hardware devices suitable for retrieving and executing instructions stored on a storage medium. As an alternative, processor 102 may include one or more electronic circuits containing a number of electronic components for performing functionality of the stored instructions.

System 100 may further include a non-transitory computer readable medium 104. Processor 102 may be coupled to a non-transitory computer readable medium 104. As used herein a non-transitory computer readable medium may be any electronic, magnetic, optical, or other physic storage device that stores executable instructions. Thus, non-transitory computer readable medium 104 may be, for example, RAM, an Electronically-Erasable Programmable Read-Only Memory (EEPROM), a storage drive, an optical disc, and the like. Non-transitory computer readable storage medium 104 may be disposed within a system, such as is shown in FIG. 1. Non-transitory computer readable medium 104 may further be a portable, external, or remote storage medium that allows processor 102 to download instructions from said storage medium. Non-transitory computer readable medium 104 may contain instructions, such as instructions 106, 108, 110, and/or 112, that may be executable by a processor such as processor 102, for global positioning system determination.

Instructions 106, when executed by a processor such as processor 102, may include instructions to transmit a message to a mobile device. As used herein, a mobile device refers to a portable device, such as a cellular telephone, tablet computer, or any other portable, handheld computing device. Transmitting a message to a mobile device at instructions 106 may include transmitting a message using short message service (SMS), multimedia messaging service (MMS), or any other messaging service, such as email, that is able to interface with a mobile device.

In some examples, the message transmitted at instructions 106 may include an interactive link. As used herein, a link refers to data or information that a person can access and follow by clicking or tapping. By clicking or tapping on the link, the person is able to access a specific document, web page, or other selected set of information. The link included within the message transmitted at instructions 106 may direct the recipient of the message to a browser page; this is discussed further herein with respect to FIG. 1.

Instructions 108, when executed by a processor such as processor 102, may include instructions to receive a notification that the link has been interacted with. As discussed previously, the link may be contained within a message, and may be interacted with by having the recipient of the message click or tap on the link. The notification may be received at a central computing device, another mobile device (i.e., a mobile device other than the one receiving the message), or a combination thereof. In some examples, the notification may be received at the source of the message transmitted at instructions 106. Said differently, the message transmitted at instructions 106 may be transmitted from, for example, a central computing device or a second mobile device. When the link contained within the message is interacted with, the same central computing device or second mobile device may receive the notification of interaction at instructions 108.

Instructions 110, when executed by a processor such as processor 102, may include instructions to determine a global positioning system (GPS) coordinate. As used herein, a GPS coordinate refers to refers to an identifier of a geographic position. Often, GPS coordinates are expressed in terms of latitude and longitude, although examples are not so limited.

The GPS coordinate may be determined at instructions 110 in response to the receipt of the notification that the link has been interacted with at instructions 108. That is, the GPS coordinate may be determined once the recipient of the message including the link interacts with the link, but not before. In some examples, instructions 110 may include instructions executable to collect a GPS setting from a browser of the mobile device. Once the link is interacted with, a browser window may open (i.e., the link may open a browser window). Among the information included within the browser window may be GPS information. Instructions 110 may include instructions to retrieve the GPS information, or GPS setting, from the browser window. In this way, a GPS coordinate is able to be gathered at a discrete time.

Instructions 112 may include instructions executable by a processor, such as processor 102, to map the determined GPS coordinate. The GPS coordinate collected at instructions 110 may be mapped onto a pre-determined route, where the pre-determined route corresponds to a transportation route to be taken by a truck driver as part of a load transportation job. By placing the determined GPS coordinate onto a map of the route, a dispatcher or employer may be able to ensure that the driver is still on the correct route.

System 100 may further include instructions executable by a processor, such as processor 102, to determine a time deviation. When the GPS location is determined at instructions 110, the time at which the particular GPS location is determine may also be recorded. This time, recorded as part of the GPS location determination, may then be used to determine a time deviation. A time deviation may be based on a predicted location that a driver is expected to be at by a particular point in time; if the driver is not at the predicted location by the expected time, a time deviation may be recorded. In some examples, if the time deviation is above a threshold time deviation, additional contact may be made with the driver to confirm the reason for the deviation. This may assist in informing dispatchers about traffic issues and backups, weather delays, or any other circumstance that may result in a driver taking longer to reach a predicted location. In addition, a time deviation may also indicate that a driver is not taking his prescribed rest breaks, has taken additional rest breaks, or has encountered a non-road delay (e.g., illness). All of this information may assist a dispatcher in managing a fleet of drivers, and may aid the shipper in providing up-to-date information to a customer.

System 100 may further include instructions executable by a processor, such as processor 102, to determine a route deviation. The route deviation may be determined based on the determined GPS coordinate, as the GPS coordinate may be mapped onto an expected route to be taken by the driver. A route deviation may be based on a predicted location that a driver is expected to be at on the route; if the driver is not at the predicted location a route deviation may be recorded. In some examples, if the route deviation is above a threshold route deviation (e.g., is more than a mile off course), additional contact may be made with the driver to confirm the reason for the deviation. This may assist in informing dispatchers about construction, weather issues (e.g., flooding), or any other circumstance that may result in a driver having to go off the prescribed route. All of this information may assist a dispatcher in route management, as the updated information may be used to update routes of other drivers so that more drivers do not encounter the same route issues.

In some examples, system 100 may include instructions executable by a processor, such as processor 102, to update an electronic log with the determined GPS coordinate. Upon collection of the GPS coordinate at instructions 110, the time and location may be entered into a driver's electronic log. This may provide ease for the driver, as he does not have to update the log himself, and may reduce errors in entries. In some examples, the update to the electronic log may occur after the determined GPS coordinate is mapped onto the pre-determined route, such that any other time and/or route deviations may also be entered into the electronic log.

System 100 may include further instructions executable by a processor, such as processor 102, to deactivate the link upon receipt of the notification of interaction with the link at instructions 108. As used herein, deactivation of a link refers to removing the ability of the link to open a browser page. Once the link is deactivated, it cannot be used to trigger a determination of a GPS coordinate using browser (as at instructions 110). In essence, the link is a single-use link; it can be interacted with one time, for one GPS collection action, and then is no longer usable and may be deleted.

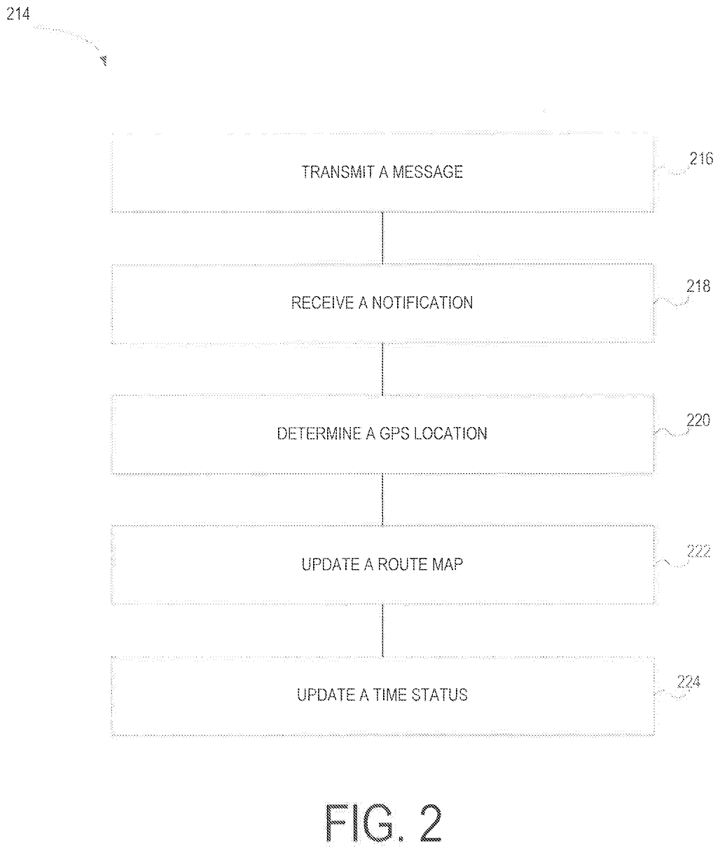

FIG. 2 is an example method 214 for global positioning system determination consistent with the present disclosure. At 216, method 214 may include transmitting a message to a mobile device. As discussed with respect to FIG. 1, the message may be an SMS, an MMS, or any other type of message. The message may include a GPS request link. The GPS request link may be, for example, a hyperlink to a browser page for the mobile device, and may require an interaction from the user of the mobile device.

At 218, method 214 may include receiving a notification that the GPS request link is activated. The GPS link may be activated through an interaction by the user of the mobile device. For example, the user may click on or tap the GPS request link, allowing a secondary page, such as a browser page to be open. In addition, upon being activated, a notification may be transmitted detailing the activation. This notification may be transmitted to, for example, a centralized computing device or a second mobile device. In some examples, the notification is transmitted to the particular device that was the source of the initial message transmitted at 216.

At 220, method 214 may include determining a GPS location. As described with respect to FIG. 1, GPS coordinates allow for a precise description of a location. The GPS location determined at 220 may be determined based on a GPS setting from a browser of the mobile device. In such examples, interacting with the GPS request link sent at 216 may open a browser page and allow the GPS settings to be collected. The GPS location may be determined in response to receiving a notification that the GPS request link is activated at 218. Said differently, collection and determination of the GPS location at 220 may only occur once a user clicks or taps on the GPS request link. In some examples, the GPS location may be collected and transmitted to the same computing device or mobile device that received the notification at 218. In other examples, the GPS location may be transmitted to a different computing device or mobile device, or to a number of computing devices and mobile devices.

At 222, method 214 may include updating a route map using the determined GPS location. As described with respect to FIG. 1, a driver may have a pre-determined route for transportation of a load. Based on the determined GPS location, the route map may be updated at 222 to include the actual location of the driver. This may allow a dispatcher to determine whether the driver has gone off route, make adjustments to the route as needed, and provide up-to-date information regarding the route to both the shipper and the customer.

At 224, method 214 may include updating a time status using the determined GPS location. As described with respect to FIG. 1, a driver may be expected to be at particular locations along the route at particular times. Because the GPS location determined at 220 includes a time stamp (i.e., the time at which the GPS location was determined), a dispatcher is able to use the determined GPS location to ensure that the driver is remaining within the expected time frame. Deviations from the expected time may allow a dispatcher to determine whether there are unexpected traffic or weather conditions that need to be accounted for, as well as update both the shipper and the customer as to the expected time of delivery.

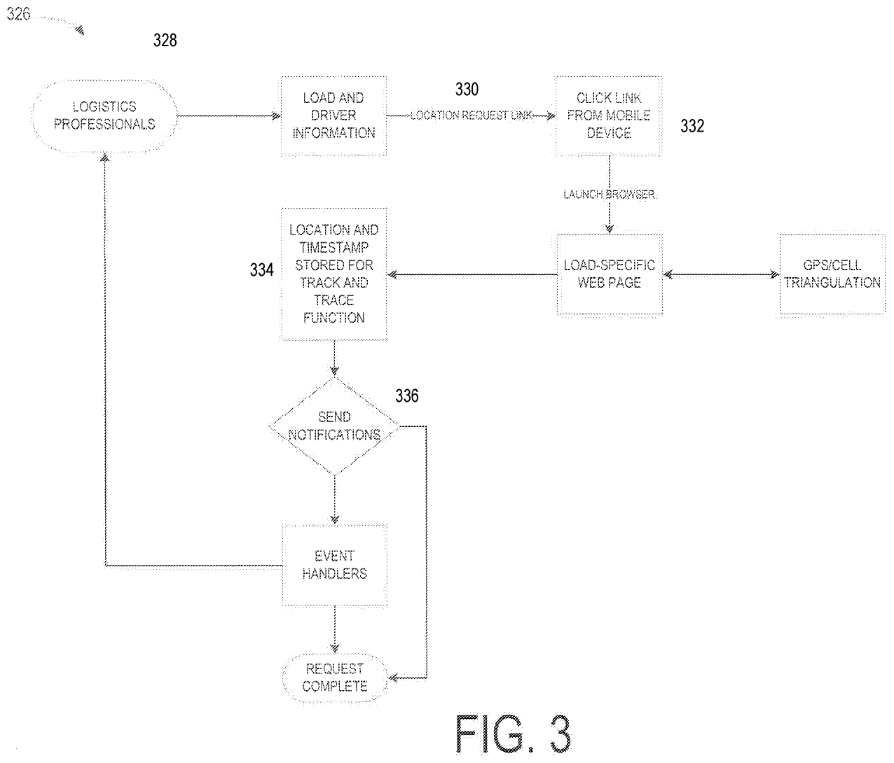

FIG. 3 is an example process flow 326 for global positioning system determination consistent with the present disclosure. Process flow 326 illustrates a flow for global positioning system determination consistent with the system and method outlined in FIG. 1 and FIG. 2, respectively. However, examples are not so limited, and the process flow 326 may be altered, have pieces added or omitted, or have other changes made.

As shown in FIG. 3, process flow 326 begins with the logistics professionals 328. The logistics professionals 328 may be a trucking company for whom a driver is driving or may be a separate company contracted by a trucking company for the sole purpose of aiding with logistics. The logistics professionals 328 may send a location request link at 330, based on the load and driver information. Then, at 332, the driver may click the link from the mobile device. By clicking the link and launching the browser, the location of the driver can be determined, as discussed with respect to FIG. 1.

Once the location and timestamp are saved at 334, notifications may be sent at 336. These notifications may include a notification that the driver has clicked on the link, as well as the saved location and/or timestamp information. As shown in FIG. 3, the notifications sent at 336 may be sent to the event handlers who, in turn, may be the same as logistics professionals 328. Once the notifications are sent at 336, the process flow 326 is complete until the next time a location determination is needed.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. Further, as used herein, “a number of an element and/or feature” can refer to one or more of such elements and/or features.

1. A non-transitory computer readable medium comprising instructions executable by a processor to:
transmit a message to a mobile device, wherein the message includes an interactive link;
receive a notification that the link has been interacted with;
determine a global positioning system (GPS) coordinate from the mobile device, wherein the GPS coordinate is determined in response to the received notification of interaction with the link; and
map the determined GPS coordinate, wherein the instructions to map the determined GPS coordinate include instructions executable to map the GPS coordinate onto a pre-determined route.

2. The non-transitory computer readable medium of claim 1, further comprising instructions executable by a processor to:
determine, based on the determined GPS coordinate, a time deviation; and
determine, based on the determined GPS coordinate, a route deviation.

3. The non-transitory computer readable medium of claim 1, further comprising instructions executable by a processor to update an electronic log with the determined GPS coordinate.

4. The non-transitory computer readable medium of claim 1, further comprising instructions executable to deactivate the link upon receipt of the notification of interaction with the link.

5. The non-transitory computer readable medium of claim 1, wherein the instructions to determine a GPS coordinate from the mobile device further comprise instructions executable to collect a GPS setting from a browser of the mobile device.

6. A method, comprising:
transmitting a message including a global positioning system (GPS) request link to a mobile device;
receiving a notification that the GPS request link is activated;
determining a GPS location, wherein:
the GPS location is determined based on a GPS setting from a browser of the mobile device; and
the GPS location is determined in response to receiving a notification that the GPS request link is activated;
updating a route map using the determined GPS location; and
updating a time status using the determined GPS location. The method of claim 6, further comprising determining a timestamp, wherein:
the timestamp is determined based on the setting of the browser of the mobile device; and
the timestamp is correlated to the determined GPS location.

8. The method of claim 6, wherein updating a route map using the determined GPS location further comprises:
placing the actual location of a driver on the route map; and
determining whether there is a route deviation.

9. The method of claim 6, wherein updating a time status using the determined GPS location further comprises:
placing the time of the determined GPS location into a time frame; and
determining whether there is a time deviation.
